(19) United States
(12) Patent Application Publication
(10) Pub. No.: US 2008/0260339 A1
(43) Pub. Date: Oct. 23, 2008

(54) Manufacture of depressed index optical fibers

(76) Inventors: Eric L. Barish, Cumming, GA (US); Robert Lingle, Norcross, GA (US); David Peckham, Lawrenceville, GA (US); Fengqing Wu, Duluth, GA (US)

Correspondence Address: Law Office of Peter V.D. Wilde, 301 East Landing, Williamsburg, VA, 23185, US

(21) Appl. No.: 12/148,891

(22) Filed: Apr. 23, 2008

Related U.S. Application Data
(63) Continuation of application No. 11/366,361, filed on Mar. 2, 2006.

(51) Int. Cl. G02B 6/036; C03B 37/018

(52) U.S. Cl. 385/127; 65/414; 65/397; 65/398

(57) ABSTRACT

Described herein is a method for making a depressed index cladding for the inner cladding of an optical fiber. The method involves making the depressed index cladding in two steps. The innermost portion of the inner cladding is produced using a soot method, thereby deriving the advantages of the soot method for the region of the cladding that carries the most optical power, then forming the remaining portion of the inner cladding layer using a rod-in-tube step. This method effectively marries the advantages and disadvantages of both methods.

### RELATED APPLICATION

The application is a Continuation of application Ser. No. 11/366,361, filed Mar. 2, 2006.

### FIELD OF THE INVENTION

This invention relates to methods for making depressed index optical fibers.

### BACKGROUND OF THE INVENTION

Depressed clad optical fibers were developed in the early 1980's as an alternative to fibers with doped cores and less heavily doped, or undoped annular cladding. See, e.g., U.S. Pat. No. 4,439,007. Using depressed cladding allows the manufacture of optical fibers with relatively low core doping. These cores produce low optical loss. More commonly, depressed cladding is used in combination with conventional core doping levels to produce high delta core designs with a now well-recognized “W” profile. A depressed inner cladding allows the use of an undoped outer cladding. Without the depressed inner cladding it would be necessary to use a doped outer cladding to realize the same “W” profile.

Applications have been developed for both single mode and multimode depressed clad fibers, and a variety of processes for the manufacture of depressed clad fibers were also developed. See e.g. U.S. Pat. No. 4,691,990, the disclosure of which is incorporated herein by reference.

Recently, there has been a renewed interest in depressed clad fibers for lightwave systems in which control of non-linear effects is important. For example, in four-wave mixing of optical frequencies in the 1.5-1.6 mm wavelength region where DWDM networks operate, a low slope, low dispersion fiber is required. A fiber structure that meets this requirement is one with multiple claddings including one or more of down-doped silica.

The most common technique for making depressed clad fibers is to dope the cladding of a fiber with fluorine or boron, thus producing a cladding with a refractive index less than the germanium-doped or pure-silica core. For example, fibers with negative normalized refractive index difference, Δn, in the range 0.05-0.7% have been obtained using fluorine doping. This approach is typically used to produce the “W” index profile and is found to be desirable for dispersion control. Manufacture of these fibers can be accomplished using any of the standard fabrication processes, including the Vapor Axial Deposition (VAD) process, but the process is complicated by the step of selectively doping the shell region with fluorine. Fluorine diffuses readily into the porous structure and it is difficult to prevent fluorine migration into the germania doped core region, thus resulting in a core that is counter-doped with fluorine. That erases the benefit of down-doping the cladding. An approach to overcome the effect of core counter-doping is to increase the germania doping level in the core. However, high doping levels in the core lead to increased scattering loss.

Fibers with depressed index cores or cladding have been produced using any of the conventional optical fiber production techniques. These include rod in tube (RIT) processes, the inside tube deposition processes: Modified Chemical Vapor Deposition (MCVD), Chemical Vapor Deposition, and Plasma Chemical Vapor Deposition PCVD, and the outside tube deposition processes: Vapor Axial Deposition (VAD) and Outside Vapor Deposition (OVD). For single mode depressed clad fibers, the rod-in-tube approach may be preferred due to the large amount of cladding material required. Preforms for these fibers require a high quality, low loss cladding tube.

The effect of counter-doping of a porous soot body described above would also appear to favor a rod-in-tube (RIT) process. In a RIT process, the core is a consolidated rod and the cladding is a consolidated tube. In this case the movement of fluorine ions is minimized since all movement is via solid/solid diffusion rather than the much faster vapor/solid permeation that occurs in a soot body. However, preform fabrication techniques that use glass over-cladding tubes suffer from contamination. Even trace amounts of contaminants adversely affect the transmission properties of the glass. Over-cladding tubes for outer cladding are effective, and frequently used, but the use of over-cladding tubes for inner cladding has not been entirely successful.

The prior art choice for inner cladding is therefore between soot methods, where the entire inner cladding is produced with time-consuming soot deposition, and RIT methods, where the use of an overclad tube for the inner cladding produces loss.

### SUMMARY OF THE INVENTION

We have developed a method that at least partly overcomes the problems just described. It involves making the fluorine doped inner cladding in two steps. The innermost portion of the inner cladding is produced using a soot method, thereby deriving the advantages of the soot method for the region of the cladding that carries the most optical power, then forming the remaining portion of the inner cladding layer using a rod-in-tube step. This method effectively marries the advantages and disadvantages of both methods.

### BRIEF DESCRIPTION OF THE DRAWING

FIG. 1 is a schematic drawing of an optical fiber profile with a depressed index formed by the two-step process of the invention;

FIG. 2 is a representation of a VAD process useful for step one of the two-step approach to producing the inner cladding;

FIGS. 3 and 4 are representations of an RIT method suitable for the second step of the inner cladding formation;

FIG. 5 is a schematic representation of an optical fiber drawing apparatus; and

FIG. 6 is a plot of delta vs distance, showing the refractive index profile in an optical fiber produced according to the invention.

### DETAILED DESCRIPTION

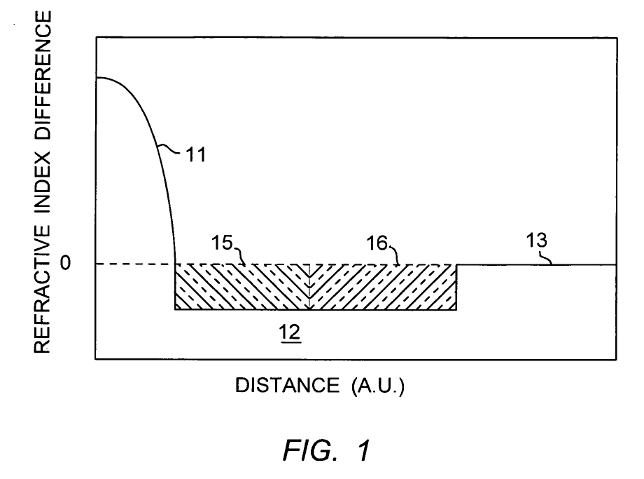

The invention is directed to the manufacture of optical fibers with refractive index profiles having at least one depressed index region. In the preferred embodiment the depressed index region comprises the inner cladding of the optical fiber. The depressed region is formed using a combination of two steps. A first step, using soot formation, produces the innermost portion of the inner cladding layer, followed by a second step, using RIT, to complete the inner cladding layer. This is illustrated schematically in FIG. 1.

With reference to FIG. 1, the refractive index profile, plotted schematically as normalized refractive index difference vs. distance, is shown with core 11, inner cladding 12, and outer cladding 13. A portion 15 of the inner cladding, adjacent the core, is formed using a soot method. A portion 16 of the inner cladding is formed using a RIT method. The zero point in the normalized refractive index difference ordinate represents the refractive index of pure silica. Δ is defined as the difference between the index of refraction at radius r and the index of refraction of pure silica

Δ=(n(r)−n_{SiO2})/n_{SiO2}

where n(r) is the index of refraction as a function of radial position and n_{SiO2} is the index of refraction of pure silica. The core has a positive Δ, the inner cladding has a negative Δ, and the outer cladding 13 has a zero Δ. Typically, the outer cladding region 13 is formed using a silica tube.

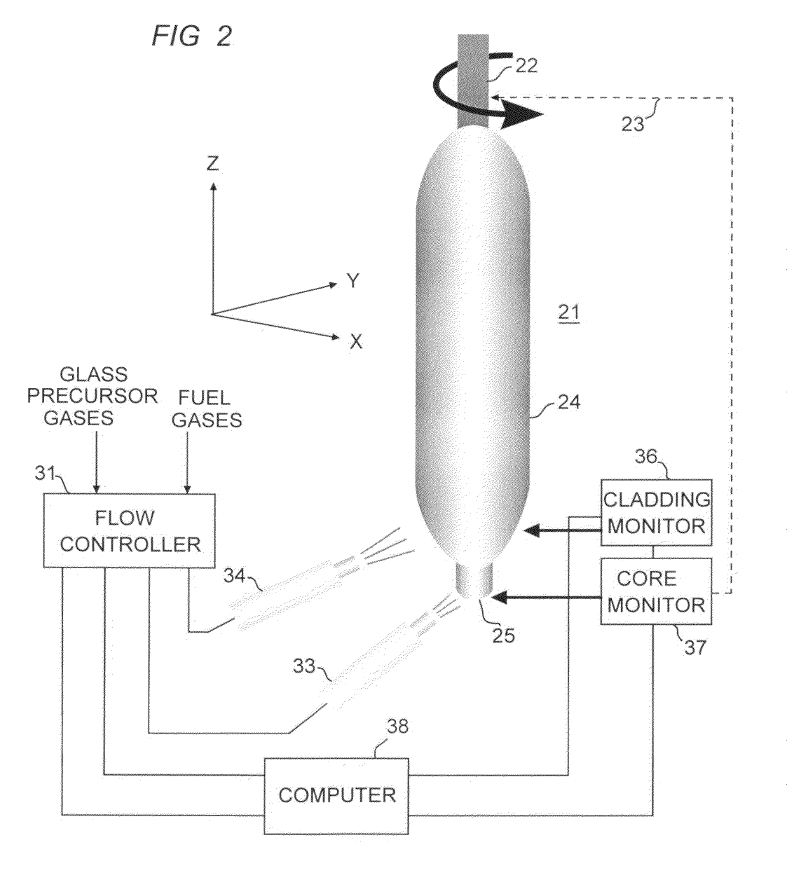

The core 11, and the innermost cladding region 15 are preferably prepared using VAD. With reference to FIG. 2, a schematic arrangement for pulling a soot boule using a VAD method is shown. The soot boule, shown generally at 21, is formed around a support rod 22. The rod is rotated during pulling as indicated by the arrow. The rotation minimizes x-y variations in the preform composition. The x-, y-, and z-axes are shown to the left of the preform. The soot boule comprises a cladding portion 24, and a core portion 25.

The core is typically silica doped with germania. In the embodiment used to demonstrate the invention, the inner cladding layer is a depressed index cladding prepared using fluorine-doped silica. After the dehydration and sintering steps, these combine to produce a finished core rod with a refractive index difference between the core and the inner cladding.

As is well known, the core and cladding may be made with a wide variety of compositions to produce many types of index profiles. More than one cladding layer may be made. More details on the basic VAD process can be found in U.S. Pat. No. 6,928,841 issued Aug. 16, 2005, which is incorporated herein by reference. It will be understood that whereas in the embodiment shown, the depressed index cladding layer is the inner cladding layer, the invention is directed to making depressed index layers in general. However, it will also be appreciated by those skilled in the art that the invention is particularly adapted to manufacturing optical fibers having profiles where the depressed index layer is in close proximity to the center core of the optical fiber, preferably adjacent the center core.

Deposition of core soot is produced by torch 33 and deposition of cladding soot by torch 34. The torches are oxy-hydrogen torches with a flame fed by oxygen and hydrogen to control the temperature of the reaction zones in a known fashion. The two torches operate in tandem as shown, one following the other, so that the core soot is deposited first, followed by the cladding soot deposited on the core soot. The flow controller and the two torch assemblies also provide the supply of glass precursor gases to the reaction zones. The glass precursor gases used to produce the core soot typically comprise SiCl₄ and GeCl₄ in an inert carrier gas. The precursor gases for the inner portion 15 of the depressed cladding may be SiCl₄ and CF₄. Other fluorine sources may also be used, e.g. XeF, SiF₄.

The pull rate is adjusted, according to variations detected at the tip location, by a core growth rate monitor similar to that shown at 37, but with the signal from the core growth rate monitor used, as indicated by feed-back loop 23 in FIG. 2, to adjust the pull rate. Reference to pulling the support rod 22 of FIG. 2 is meant to include any arrangement wherein the position of the preform is controllably moved in relation to the position of torches 33 and 34. Either the support rod or the torches may be moved. These are equivalents in that the movement required is relative, so that movement of one or the other if stated neabs relative movement.

Improved control of the VAD process may be obtained by independently monitoring the growth rates of the core soot and the cladding soot. This may be implemented using independent monitors 36 and 37 for the cladding and core growth rates respectively. Any change in either is fed back to computer 38, which computes the control action sent to flow controlling unit 31. As just described, the flow controlling unit controls the flow of glass precursor gases to the reaction zones of both the core soot and the cladding soot, and controls the temperature of both reactions by controlling the flow of fuel gases to the torches 33 and 34. In the arrangement shown, control of the core soot and cladding soot reactions is independent, and may be implemented by controlling the flow rate of the precursor gases, the fuel gases, or both. This is described in more detail in U.S. Pat. No. 6,923,024, issued Aug. 2, 2005, which is incorporated by reference herein.

Following soot deposition the porous soot body is consolidated by heating to a temperature sufficient to sinter the silica particles into a solid, dense, glass rod. Consolidation is typically performed by heating the soot body to a temperature of 1400° C. to 1600° C. After cooling, the solid rod is ready for a RIT process.

The second portion 16 of the depressed cladding layer 12 is formed using a RIT method. The tube is a fluorine-doped silica tube as described earlier. The level of doping in the fluorine tube is chosen to provide a refractive index for the glass tube that is at least as negative as that of the innermost cladding region 15. The doping level in the tube may be graded but is typically uniform.

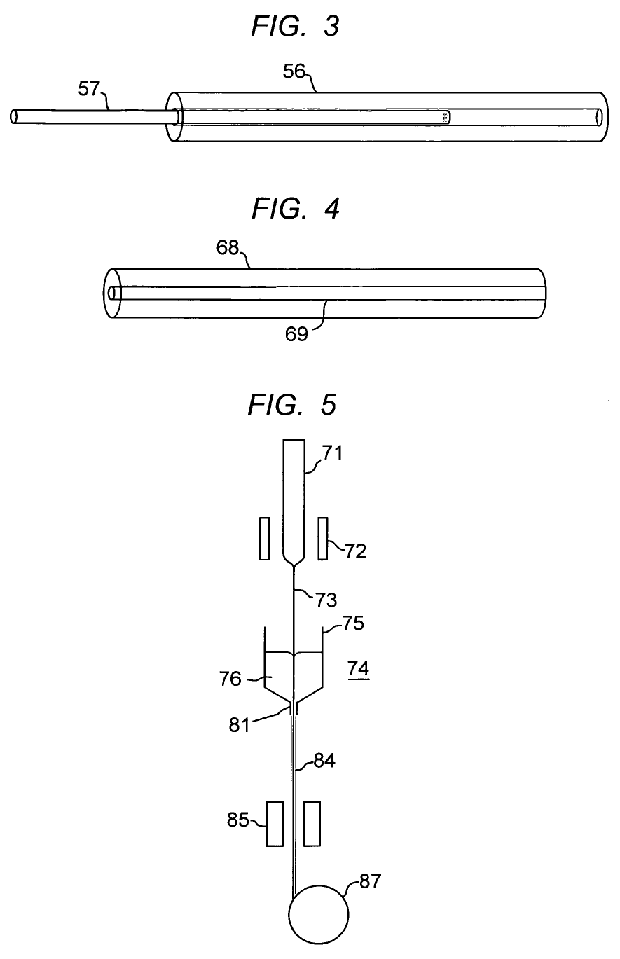

A typical rod-in-tube approach is shown in FIGS. 3 and 4. The drawing is not to scale. The cladding tube is shown in FIG. 3 at 56. A typical length to diameter ratio is 10-15. The core rod 57 is shown being inserted into the cladding tube. The rod at this point is typically already consolidated. After assembly of the rod 57 and tube 56, the combination is fused to produce the final preform 68 shown in FIG. 4, with the core 69 integral with the cladding but with a small refractive index difference.

In the embodiment represented by FIG. 1, two overclad tubes are used. The first overclad tube, comprising fluorine-doped silica, forms the region 16 in the profile. A second, undoped silica, overclad tube forms the outer cladding 13. Suitable dimensions for these tubes, and RIT techniques, are known in the art and details are not required for one skilled in the art to implement the profile shown.

The completed preform is then used for drawing optical fiber in the conventional way. FIG. 5 shows an optical fiber drawing apparatus with preform 71 and susceptor 72 representing the furnace (not shown) used to soften the glass preform and initiate fiber draw. The drawn fiber is shown at 73. The nascent fiber surface is then passed through a coating cup, indicated generally at 74, which has chamber 75 containing a coating prepolymer 76. The liquid coated fiber from the coating chamber exits through die 81. The combination of die 81 and the fluid dynamics of the prepolymer, controls the coating thickness. The prepolymer coated fiber 84 is then exposed to UV lamps 85 to cure the prepolymer and complete the coating process. Other curing radiation may be used where appropriate. The fiber, with the coating cured, is then taken up by take-up reel 87. The take-up reel controls the draw speed of the fiber. Draw speeds in the range typically of 1-20 m/sec. can be used. It is important that the fiber be centered within the coating cup, and particularly within the exit die 81, to maintain concentricity of the fiber and coating. A commercial apparatus typically has pulleys that control the alignment of the fiber. Hydrodynamic pressure in the die itself aids in centering the fiber. A stepper motor, controlled by a micro-step indexer (not shown), controls the take-up reel.

Coating materials for optical fibers are typically urethanes, acrylates, or urethane-acrylates, with a UV photoinitiator added. The apparatus in FIG. 5 is shown with a single coating cup, but dual coating apparatus with dual coating cups are commonly used. In dual coated fibers, typical primary or inner coating materials are soft, low modulus materials such as silicone, hot melt wax, or any of a number of polymer materials having a relatively low modulus. The usual materials for the second or outer coating are high modulus polymers, typically urethanes or acrylics. In commercial practice both materials may be low and high modulus acrylates. The coating thickness typically ranges from 150-300 μm in diameter, with approximately 240 μm standard.

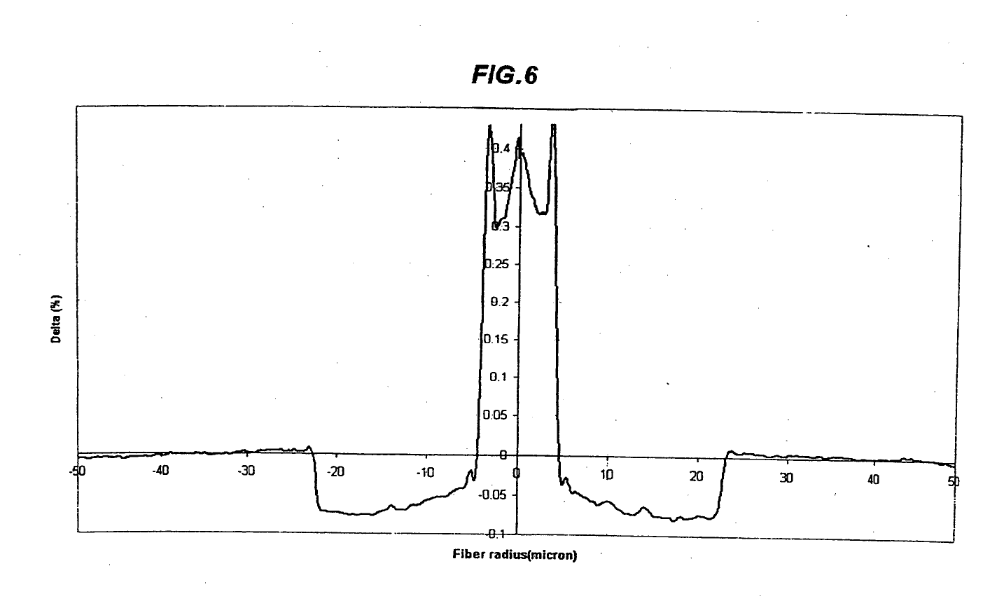

The invention in principle was demonstrated as described above, and a specific design of an optical fiber refractive index profile according to the invention is shown in FIG. 6. The core is silica doped with Ge, with a Δ of approximately 0.0035. The innermost portion of the depressed cladding is produced using SiCl₄ and CF₄ and results in a deep depressed region as shown. The portion of the depressed cladding produced by soot deposition extends to approximately 13 microns from the center of the optical fiber. The Δ of the soot deposited inner cladding region varies from approximately −0.0003 to −0.0008. The remaining portion of the depressed cladding, extending from approximately 13 microns to approximately 23 microns, is produced with the fluorine-doped overclad tube. The ratio of the inner-cladding (12) diameter to the core (11) diameter is approximately 5, and will normally range from 3-8.

Use of the two-step cladding formation process of the invention makes possible the fabrication of very wide and very deep depressed index regions. The depressed index region in FIG. 6 is approximately 19 microns wide, with the major portion having a depressed index more negative than −0.0008. The width, W_{D}, of the depressed index region may be expressed as:

W_{D}=(D_{F}−D_{C})/2

where D_{F} is the diameter of the F-doped region (appr. 46 microns in FIG. 6) and D_{C} is the diameter of the core (approximately 8 microns in FIG. 6).

Since an important advantage in using soot derived glass for the innermost cladding is to provide high quality, low loss glass in the outer region of the optical power envelope of the propagating wave, the width of the soot derived portion of the depressed cladding is preferably substantial, i.e. at least 0.25 W_{D}, and preferably at least approximately 0.5 W_{D}. Also in a preferred case, at least 50% of the width of the soot derived glass depressed index inner-cladding glass has a Δ more negative than −0.0005. It is also preferred that essentially all of the tube derived glass has a Δ more negative than −0.0005. Combining these characteristics, at least 75% of the width W_{D} of the depressed layer will have a Δ more negative than −0.0005.

In the preferred embodiment of the invention, wherein a portion of the depressed index region is derived from VAD-soot and a portion of the depressed index region is derived from RIT overclad tube, the profile has the following characteristics:
W_{D}[(D_{F}−D_{C})/2]>10 microns, preferably greater than 14 microns
>75% of the depressed inner-cladding (12) Δ more negative than −0.0005.

The outer cladding 13 is preferably un-doped silica, and may extend to the outer surface of the fiber. Alternatively, other profile features may be incorporated, such as an up-doped ring to control microbending losses.

In the finished preform, it is expected that the depressed region will exhibit a physical interface or discontinuity between the soot-derived glass and the tube-derived glass. Thus the preform can be characterized structurally by a depressed region comprising a portion of VAD or OVD soot-derived glass and a portion of overclad tube-derived glass. These characterizations have acquired specific meaning in the context of this specification, and are therefore terms that would be clear and definite to those skilled in the art. Since the optical fiber drawn from the preform is known to replicate all of the material characteristics of the preform, the optical fiber may be defined by the same characteristics.

The terms up-doped and down-doped as used herein are also terms well known to those skilled in the art. An up-doped glass or glass region is one that is doped to have a refractive index greater than that of pure silica. A down-doped glass or glass region is one that is doped to have a refractive index less than that of pure silica.

In concluding the detailed description, it should be noted that it will be obvious to those skilled in the art that many variations and modifications may be made to the preferred embodiment without substantial departure from the principles of the present invention. All such variations, modifications and equivalents are intended to be included herein as being within the scope of the present invention, as set forth in the claims.

1. Method comprising the steps of:
(a) forming a core rod comprising an up-doped core region,
(b) depositing by VAD or CVD a down-doped cladding,
(c) consolidating the first down-doped cladding, to form a core/clad rod with an up-doped core and a down-doped cladding,
(d) inserting the core clad rod into a cladding tube, the cladding tube consisting essentially of a down-doped tube, and
(e) heating the cladding tube to collapse the cladding tube around the core/clad rod.

2. The method of claim 1 wherein the cladding tube has a uniform doping level.

3. The method of claim 2 wherein the cladding tube is down-doped with fluorine.

4. Method comprising the steps of:
(a) in a first VAD torch:
(i) flowing together a flow of one or more glass precursor gases, and a flow of fuel gas, to form a first soot gas mixture,
(ii) igniting the first soot gas mixture to form a first soot flame thereby producing a first glass soot,
(b) in a second VAD torch:
(i) flowing together a flow of one or more glass precursor gases, and a flow of fuel gas, to form a second soot gas mixture, the second soot gas mixture comprising a fluorine compound,
(ii) igniting the second soot gas mixture to form a second soot flame thereby producing a second glass soot,
(c) directing a support rod to the first and second VAD torches in tandem, with the first VAD torch preceding the second VAD torch so that the first VAD torch deposits the first glass soot to form a first soot coating, and the second VAD torch deposits the second glass soot on the first glass soot coating,
(d) moving the support rod relative to the torches from a start point to an end point to produce a bi-layer of soot,
(g) heating the bi-layer of soot to consolidate the soot into a glass rod, the glass rod having an outer layer comprising fluorine-doped glass,
(h) inserting the glass rod into a glass tube, the glass consisting essentially of fluorine-doped glass, so that the fluorine-doped glass tube surrounds the fluorine-doped glass outer layer of the glass rod, and
(i) heating the glass tube to collapse the glass tube around the glass rod and produce a preform with a fluorine-doped depressed index cladding region.

5. The method of claim 4 wherein the first glass soot comprises germanium.

6. The method of claim 4 comprising the additional steps of:
heating the preform to a softening temperature, and
drawing a glass fiber from the preform.

7. An optical fiber comprising an up-doped core surrounded by a down-doped inner cladding layer, and an outer cladding layer, wherein the down-doped inner cladding layer comprises a first down-doped cladding region adjacent the core, the first cladding region comprising VAD or OVD soot derived glass, and a second down-doped cladding region surrounding the first cladding region, the second cladding region comprising overclad tube derived glass, wherein the overclad tube glass consists essentially of down-doped glass.

8. The optical fiber of claim 7 wherein the down-doped cladding regions are doped with fluorine.

9. The optical fiber of claim 7 wherein the inner cladding layer has a width WD defined by:
W_{D}=(D_{F}−D_{C})/2
where D_{F} is the diameter of the down-doped region and D_{C} is the diameter of the core, and W_{D} is greater than 12 microns.

10. The optical fiber of claim 7 wherein the width of the first down-doped cladding region is at least 0.25 W_{D}.

11. The optical fiber of claim 7 wherein at least 50% the first down-doped cladding region has a delta more negative than −0.0005.

12. The optical fiber of claim 7 wherein the second down-doped cladding region has a delta more negative than −0.0008.

13. The optical fiber of claim 7 wherein at least 75% of the width of the depressed cladding region W_{D} has a delta more negative than −0.0005.

14. The optical fiber of claim 7 having a water peak of less than 0.31 dB/km at 1383 nm.
